(19) United States
(12) Patent Application Publication
(10) Pub. No.: US 2005/0026081 A1
(43) Pub. Date: Feb. 3, 2005

(54) Volume hologram recording photosensitive composition, and volume hologram recording medium using the same

(75) Inventor: Koichi Kawamura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/893,903

(22) Filed: Jul. 20, 2004

(30) Foreign Application Priority Data
Jul. 29, 2003 (JP) 2003-281476

(51) Int. Cl. G03C 1/73; G03H 1/04

(52) U.S. Cl. 430/281.1; 430/1; 430/2

(57) ABSTRACT

The present invention provides a volume hologram recording photosensitive composition comprising a binder polymer, a polymerizable compound, and preferably 0.1 to 3.0% by mass of a photopolymerization initiator represented by formula (I): S-L-A (I); and a volume hologram recording medium having a photosensitive layer comprising this composition. In formula (I), S represents a light absorbing moiety having a chromophoric group structure in which absorption giving an absorption coefficient of 1000 or more is caused for wavelengths longer than 300 nm; A represents an active moiety S interacting with the light absorbing moiety that is optically excited, so as to generate a free radical; and L represents a linking group for linking the light absorbing moiety S with the active moiety A. The two moieties are linked through a non-conjugated bond.

### CROSS-REFERENCE TO RELATED APPLICATION

This application claims priority under 35 USC 119 from Japanese Patent Application No. 2003-281476, the disclosure of which is incorporated by reference herein.

### BACKGROUND OF THE INVENTION

1. Field of the Invention

The present invention relates to a new photosensitive composition wherein volume holograms can be recorded; and a volume hologram recording medium using the composition.

2. Description of the Related Art

As photosensitive compositions for producing volume holograms, Du Pont's Omni Dex (trade name) series are available on the market, the compositions which are each made mainly of a radical polymerizable monomer, a binder polymer, a radical photopolymerization initiator, and a sensitizing dye and which use a refractive index difference between the radical polymerizable monomer and the binder polymer. When a film made from any one of the photosensitive compositions is subjected to interference exposure, radical polymerization of the radical polymerizable monomer is started in portions thereof where the received light is intense, so that a concentration gradient of the radical polymerizable monomer is generated. Consequently, molecules of the radical polymer monomer diffuse and move from portions where the received light is faint to the above-mentioned portions where the light is intense. As a result, in accordance with the intenseness and the faintness of the interferential light, condensation and rarefaction of the molecules of the radical polymerizable monomer are generated. This appears as a refractive index difference. These compositions have the best performance among currently reported photopolymers for volume holograms. However, it is pointed out that there is room for improvement in heat resistance and transparency thereof.

As another example of the photosensitive composition for volume hologram, there are disclosed those using both radical polymerization and cationic polymerization, for example, a composition using both a monomer having a diallyfluorene skeleton, as a radical polymerizable monomer having a high refractive index, and a cationic polymerizable monomer having a smaller refractive index than the radical polymerizable monomer (see, for example, Japanese Patent No. 2873126). In this composition, the high-refractive-index component is polymerized by radical polymerization at the time of hologram exposure and next the resultant image is fixed by cationic polymerization in fixing-exposure. Meanwhile, a composition using cationic polymerization was also proposed (see, for example, U.S. Pat. No. 5,759,721). This composition has an advantage in that polymerization inhibition by oxygen, which is a problem in radical polymerization systems, does not occur. However, this composition has problems in that the photospeed of the cationic polymerization is low and further it is difficult for the system to have sensitivity in a longer wavelength range.

As a composition excellent in heat resistance, a composition system was proposed which uses both an inorganic material network and a photopolymerizable monomer (see, for example, Japanese Patent No. 2953200). Since the inorganic material which can form a network is used as a binder in this composition, the composition has advantages in superior heat resistance, environmental protection and mechanical strength; further, a large refractive index difference between the inorganic material and the photopolymerizable organic monomer can be obtained. However, the composition has problems in that: a hologram recording film made from the composition is brittle and is inferior in flexibility, workability and suitability for coating; and further since the compatibility between the inorganic binder and the organic monomer is poor, it is difficult to prepare a homogeneous coating material therefrom.

Meanwhile, as hologram recording materials with improved refractive index difference, known examples use a combination of an aromatic-ring-containing binder polymer having a high refractive index with a fluorine-containing monomer having a low refractive index (see, for example, Japanese Patent Application Laid-Open (JP-A) Nos. 5-210343, 5-210344, and 5-257416). However, this combination has a problem in that the sensitivity thereof to light during interference exposure is not very high since the polymerization reactivity of the monomer is insufficient. It is also disclosed that in order to improve this combination and raise the polymerizability of the fluorine-containing monomer, a polyfunctional acrylate is added thereto. However, this method causes a problem of damaging the original low refractivity of the fluorine-containing monomer. Furthermore, this combination has problems such that an intensely-exposed portion, wherein a polymer from the fluorine-containing monomer is present at a high ratio, is mechanically weak. Further, yellowing occurs easily due to use of the aromatic-ring-containing binder polymer.

For the same purpose, there is disclosed an example which uses a combination of a low-refractive-index binder polymer made from a fluorine-containing acrylic monomer and a fluorine-free acrylic monomer with a high-refractive-index, aromatic-ring-containing monomer (see, for example, JP-A No. 6-67588). However, this example also has problems in that the low refractivity of the fluorine-containing acrylic monomer is damaged by copolymerization thereof with the fluorine-free acrylic monomer; moreover, yellowing occurs easily due to the aromatic ring of the aromatic-ring-containing monomer.

An index showing the performance of volume holograms is a refractive index variation (Δn). This value is calculated in accordance with Kogelnik's coupled wave theory. It can be said that the larger the value, the better the hologram material. However, in all known volume hologram recording materials, as described above, the refractive index variations (Δn) thereof, which show hologram performance, are at most about 0.06. Thus, further improvement in a refractive index variation Δn is currently desired in order to apply hologram materials to new optical elements or the like.

Needless to say, considering the application of hologram materials to various fields, such as the field of optical elements, it is preferable for a material to be sufficiently satisfactory not only in hologram recording characteristics such as refractive index difference, sensitivity and transparency, but also in other various characteristics including physical properties such as film strength and heat resistance.

In any material for forming a volume hologram, a photopolymerization initiator for performing interference exposure is essential. In order to improve the sensitivity of such a hologram recording photosensitive composition, it is desirable that the photopolymerization initiator is added at a slightly high concentration (for example, 5% by weight). However, in order to record an image uniformly in regions ranging from the upper portion of a photosensitive material film having a large thickness, such as a volume hologram film, to the lower portion thereof, it is also important that the film uniformly transmits light. From this viewpoint, it is preferable that the photopolymerization initiator is added at a low concentration. It is difficult to keep the balance therebetween. Furthermore, when a low molecular weight compound, such as a photopolymerization initiator, is added to a volume hologram, the compound reacts at the time of hologram recording. Consequently, this low molecular weight compound moves in the film independently of primary polymerization, whereby an undesired concentration gradient is generated. This gradient is added to the concentration gradient based on the primary polymerization, thereby generating double concentration gradients. As a result, a fall in recording performance occurs.

For such reasons, it is hoped that an originally undesirable change in refractive index caused by diffusion of the photopolymerization initiator is suppressed by adding a low-concentration photopolymerization initiator, thereby increasing the refractive index variation (Δn) of the hologram. However, there is a major problem in that along with a decrease in the added amount of the initiator, the sensitivity of the hologram, necessary for recording, is extremely lowered. Thus, from a practical standpoint, there has been a limit to improve the performance of the hologram by adjusting the added amount of a known photopolymerization initiator.

Accordingly, a volume hologram recording photosensitive composition is desired which has excellent recording sensitivity and can carry out polymerization reaction at a high photospeed even if only a small amount of a photopolymerization initiator is used at the time of interference exposure.

A volume hologram recording medium excellent in recording sensitivity is also desired.

Moreover, a volume hologram recording medium is desired wherein the amount of a photopolymerization initiator or a decomposed product therefrom which remains in a finally-obtained volume hologram film is minimal.

### SUMMARY OF THE INVENTION

As a result of the inventor's eager investigation, the inventor has discovered that the above-mentioned demands can be met by using a specific photopolymerization initiator, and have made the invention.

A first aspect of the invention provides a volume hologram recording photosensitive composition comprising a binder resin, a polymerizable compound, and a photopolymerization initiator represented by formula (I):
S-L-A Formula (I)
wherein S represents a light absorbing moiety having a chromophoric group structure in which absorption giving an absorption coefficient of 1000 or more is caused for wavelengths longer than 300 nm; A represents an active moiety interacting with the light absorbing moiety S that is optically excited, so as to generate a free radical; and L represents a linking group for linking the light absorbing moiety S with the active moiety A.

A second aspect of the invention provides a volume hologram recording medium comprising a support having provided thereon a photosensitive layer made of a volume hologram recording photosensitive composition comprising a binder resin, a polymerizable compound, and a photopolymerization initiator represented by formula (I) described above.

In the volume hologram recording photosensitive composition of the invention, superior recording sensitivity can be obtained even if the initiator is added at a low concentration. This is because the photosensitive composition has two partial moieties having different functions, that is, the light absorbing moiety S and the active moiety A. The reason for this is specifically as follows. The photopolymerization initiator of formula (I) has a sensitizing dye moiety, which is the light absorbing moiety S, and an initiator moiety, which is the active moiety A. These moieties are not linked with each other through any direct bond (single bond) or any conjugated bond wherein the chromophoric group of the dye is conjugated with that of the initiator, but the moieties are linked in a form in which the chromophoric groups are not conjugated with each other through the linking group L, preferably the linking group L containing one or more bonds selected from the group consisting of methylene, ester, amide, sulfonamide, ether and thioether bonds. This structure causes the distance between the sensitizing dye and the initiator to remain constant regardless of the concentration of the added initiator. This distance is determined by the length of the linking group L for linking the sensitizing dye chromophoric group S and the initiator chromophoric group A.

In other words, the moiety sensitized by exposure to light is positioned very closely to the moiety which is activated by energy of the light to generate an initiating species; thus, electrons are rapidly shifted therebetween. In a composition wherein a sensitizing dye and a polymerization initiator are separately incorporated, when these components are dispersed homogeneously at a satisfactory level and further the concentration of the initiator is low, the distance between the sensitizing dye and the initiator is longer than in the composition including the specific polymerization initiator, wherein the sensitizing dye moiety and the initiator moiety are linked with each other, when the concentrations of the initiators in the two compositions are equal to each other. That is, the use of the photopolymerization initiator of formula (I) causes the generation of active species to be remarkably increased as compared with the use of the sensitizing dye and the polymerization initiator which are not linked, between which electrons are shifted. For this reason, it appears that sufficient sensitivity can be attained even if the initiator is added at a low concentration.

In a volume hologram film which is finally obtained from the volume hologram recording photosensitive composition and the volume hologram recording medium of the invention, the amount of the added photopolymerization initiator is smaller than in known hologram films. Consequently, initiator molecules which have not reacted and/or decomposed products therefrom remain in only small amounts. Thus, the volume hologram film has an advantage in that adverse effects of undesired residues on physical and optical properties of the volume hologram film can be suppressed to a minimum.

According to the volume hologram recording photosensitive composition of the invention, sufficient recording sensitivity can be attained even if the content of the photopolymerization initiator is small. Furthermore, it is possible to obtain a volume hologram recording medium wherein the following adverse effects are effectively suppressed: adverse effects of an unreacted product of the photopolymerization initiator or decomposition residues thereof on physical properties of its hologram film. Sufficient recording sensitivity can be attained by this recording medium. As for the resultant hologram film, adverse effects of an unreacted product of the photopolymerization initiator or decomposition residues thereof on physical properties of the medium are suppressed, and high optical transparency is exhibited. Accordingly, this hologram film exhibits a large refractive index change.

### DETAILED DESCRIPTION OF THE INVENTION

A volume hologram recording photosensitive composition of the invention includes, as essential components, a binder polymer (A), a polymerizable compound (B), and a photopolymerization initiator (C), and a compound represented by formula (I) is contained as the photopolymerization initiator (C).

The following describes the essential components of the volume hologram recording photosensitive composition of the invention one by one. First, the photopolymerization initiator (C), which is an important component in the invention, is described.

Photopolymerization Initiator (C)

Photopolymerization initiating systems known in prior art are each characterized by comprising both a sensitizing dye wherein absorption is caused in a visible wavelength range and an initiator. The mechanism for generating an active species from the sensitizing dye and the initiator is as follows: an electron transfer reaction between the sensitizing dye excited by irradiation with visible rays and the initiator advances a further reaction to generate radicals, cations or other active species from the initiator, and the active species cause a polymerization reaction to occur and advance.

In an electron transfer reaction in any solid matrix made of a hologram recording photosensitive composition or the like, a sensitizing dye and an initiator therein cannot be freely diffused, which is different from electron transfer reaction in any solution. Therefore, efficiency of the electron transfer largely depends on the distance between the sensitizing dye and the initiator. In a state wherein the distance between the two is small, the electron transfer advances effectively. However, if the distance is large, efficiency falls as an exponential function of the distance. The distance between the sensitizing dye and the initiator in the solid matrix is determined by the concentration of the added initiator. When the concentration is low, the distance naturally becomes long, so that the efficiency of the electron transfer falls drastically. That is, high sensitivity cannot be expected within the region where the initiator is added at low concentrations, the region being desired for hologram recording photosensitive compositions.

The invention uses a photopolymerization initiator represented by formula (I), which has in a single molecule thereof both a light absorbing moiety having a function as a sensitizing dye and an active moiety having a function for generating an active species, these moieties being linked with each other through a given linking group.

The photopolymerization initiator represented by formula (I) is specifically described. In the initiator made of an exemplified compound S1, which will be described later, the distance between the light absorbing moiety (sensitizing dye) and the active moiety (initiator) is about 12 Å from MM2 molecule calculation. The following case is given as an example: a case in which this initiator is included in a photosensitive composition at a concentration of 3 mmol/dm³ (the concentration of exemplified compound S1 in the composition corresponds to 0.3% by mass). When the sensitizing dye and the initiator are separately included at this concentration, the distance between the two is regarded as 51 Å. The difference between the obtained distance values is about 40 Å. According to documents and others, it is reported that each time the distance becomes large by several angstroms, the transfer speed of electrons falls several hundred times to several thousand times. It is evident from this fact that in the case of such an added amount, sufficient sensitivity cannot be obtained if the specific polymerization initiator according to the invention is not used.

As the photopolymerization initiator in the invention, a radical photopolymerization initiator or a cationic photopolymerization initiator can be used. The composition of the invention comprises, as the radical photopolymerization initiator or the cationic photopolymerization initiator, a compound represented by formula (I):
S-L-A Formula (I)
wherein S represents a light absorbing moiety having a chromophoric group structure in which absorption giving an absorption coefficient of 1000 or more is caused for wavelengths longer than 300 nm; A represents an active moiety interacting with the light absorbing moiety that is optically excited, so as to generate a free radical; and L represents a linking group for linking the light absorbing moiety S with the active moiety A.

The linking group L may be a linking group containing one or more bonds selected from the group consisting of methylene, ester, amide, sulfonamide, ether and thioether bonds, and may be a linking group wherein two or more out of these bonds are combined. It is indispensable that the light absorbing moiety S and the active moiety A are linked with each other through a non-conjugated bond. That is, the chromophoric group which the active moiety A has and the chromophoric group which the light absorbing moiety S has are linked at an interval through the linking group L, so as to be non-conjugated with each other without bonding these chromophoric groups to each other through any direct covalent bond or any conjugated bond and without any partial structure of the active moiety A partially constituting the chromophoric group which the light absorbing moiety S has.

The light absorbing moiety S preferably has a partial structure as a chromophoric group which absorbs a given wavelength, and is preferably a residue of a dye selected from melocyanine, cyanine, squalium, dibenzylacetone, xanthene, triphenylmethane and acridinium dyes, or a residue of a compound selected from thioxanthone, anthracene, phenanthrene, pyrene, acridine, carbazole and phenothiazine, or a residue of a derivative of the compound.

The compound including the light absorbing moiety S having a chromophoric group structure in which absorption giving an absorption coefficient of 1000 or more is caused for wavelengths longer than 300 nm may be a known light absorbent which is conventionally used together with an activating agent. Specific examples thereof include chalcone compounds, dibenzylacetone compounds, melocyanine dyes, thiopyrylium dyes, pyrylium dyes, dialkylaminostilbene compounds, acridinium dyes, xanthene dyes, thiazene dyes, cyanine dyes, squalium dyes, triphenylmethane dyes, and thioxanthone.

Other examples thereof include polynuclear aromatic compounds such as anthracene, phenanthrene, and pyrene; and polynuclear hetero aromatic compounds such as acridine, carbazole and phenothiazine and derivatives thereof.

Typical examples of the compound having the active moiety A interacting with the light absorbing moiety S that is optically excited, so as to generate a free radical include bisimidazole compounds; onium compounds such as diphenyliodonium and triphenylsulfonium salts; trichloromethyl-substituted S-triazine compounds; amine compounds such as N-phenylglycine, triethanolamine and hydrazine; phosphorus compounds such as triphenylphosphine and tri-n-butylphosphine; sulfinic acid compounds such as sodium p-toluenesulfinate; sulfonates such as methyl p-toluenesulfonate; heterocycle compounds such as oxazole and imidazole; enolate compounds such as dimedone; tin compounds such as tributylbenzyltin; allylthiourea and oxime esters; boron compounds such as triphenyl-n-butylborate; pyridinium salts such as 1-methoxy-4-carbomethoxypyridinium tetrafluoroborate, as described in “Research Disclosure”, Vol. 200 (December 1980) Item 20036. A residue of any one of these compounds can be used as the active moiety A of the specific photopolymerization initiator of formula (I).

The linking group L for linking the light absorbing moiety S with the active moiety A is preferably a linking group containing one or more bonds selected from the group consisting of methylene, ester, amide, sulfonamide, ether and thioether bonds. Specific examples thereof include an ester bond represented by the following formula (a) or (b), amide bonds represented by the following formulae (c) to (f), a sulfonamide bond represented by the following formula (g), and ether, thioether and amino bonds: 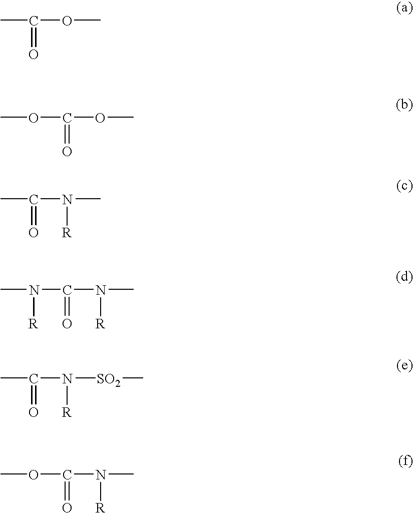
wherein Rs each independently represent a hydrogen atom, an alkyl group or an aryl group, 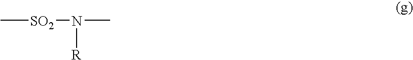
wherein R represents a hydrogen atom, an alkyl group or an aryl group.

Particularly preferable examples of the compound represented by formula (I) include compounds wherein the light absorbing moiety S has a structure selected from residues of melocyanine, cyanine, squalium and acridinium dyes, and polynuclear aromatic and polynuclear hetero aromatic compounds; the active moiety A is an S-triazine or 1-alkoxypyridinium residue containing a trichloromethyl group; and the linking group L is any one selected from ester, amide and sulfonamide bonds.

The melocyanine dye used for synthesis of the compound represented by formula (I) may be a dye wherein a functional group necessary for being linked with the active moiety A is introduced into a known melocyanine dye. Examples of the known melocyanine dye suitable for synthesis of the initiator represented by formula (I) include compounds described in F. M. Hamer et al., “THE CYANINE DYES AND RELATED COMPOUNDS” (1964), pp. 511-611.

Examples of such a melocyanine dye include dyes represented by the following formula (II), and the melocyanine dye suitable for the synthesis of the photopolymerization initiator of formula (I) is not limited to the dye.

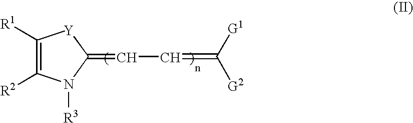

In formula (II), R¹, R² and R³ each independently represent a hydrogen atom, or an alkyl, aryl or allyl group, Y represents a bivalent atom or atomic group selected from the group consisting of —O—, —S—, —NR¹— wherein R¹ has the same meanings as in formula (II), —Se—, —C(CH₃)₂—, and —CH═CH—. R¹ and R² may be combined with the carbon atoms to which they are bonded, so as to form a ring. The alkyl, aryl or allyl group may have a substituent. Examples of the substituent, which can be introduced into the group, include halogen atoms and alkoxy groups.

In formula (II), n represents 0, 1 or 2. G¹ and G² may be the same or different, and each represent a hydrogen atom, or a cyano, alkoxycarbonyl, aryloxycarbonyl, acyl, arylcarbonyl, alkylthio, arylthio, alkylsulfonyl, arylsulfonyl, or fluoroalkylsulfonyl group provided that both G¹ and G² are not hydrogen atoms.

The alkoxycarbonyl, aryloxycarbonyl, acyl, or arylcarbonyl group may have a substituent. Examples of the substituent, which can be introduced into the group, include alkyl and aryl groups.

G¹ and G² may be combined with the carbon atom to which they are bonded, so as to form a ring made of nonmetallic atoms. In the case where this ring, made of nonmetallic atoms, is formed, the ring may have a ring structure which is usually used as an acidic nucleus in a melocyanine dye, and examples thereof include:
(a) 1,3-dicarbonyl nuclei such as 1,3-indanedione, 1,3-cyclohexanedione, 5,5-dimethyl-1,3-cyclohexanedione, and 1,3-dioxane-4,6-dione;
(b) pyrazolinone nuclei such as 3-methyl-1-phenyl-2-pyrazoline-5-one, 1-phenyl-2-pyrazoline-5-one, and 1-(2-benzothiazolyl)-3-methyl-2-pyrazoline-5-one;
(c) isooxazolinone nuclei such as 3-phenyl-2-isooxazoline-5-one, and 3-methyl-2-isooxazoline-5-one;
(d) oxyindole nuclei such as 1-alkyl-2,3-dihydro-2-oxyindole;
(e) 2,4,6-triketohexahydropyrimidine nuclei such as barbituric acid, 2-thiobarbituric acid, and derivatives thereof, examples of the derivatives including 1-alkyl derivatives such as 1-methyl and 1-ethyl derivatives, 1,3-dialkyl derivatives such as 1,3-diethyl derivatives and 1,3-dibutyl derivatives; 1,3-diaryl derivatives such as 1,3-diphenyl derivatives, 1,3-di(p-chlorophenyl) derivatives, 1,3-di(p-ethoxycarbonylphenyl) derivatives; and 1-alkyl-3-aryl derivatives such as 1-ethyl-3-phenyl derivatives;
(f) 2-thio-2,4-thiazolidinedione nuclei such as rhodanine and derivatives thereof, examples of the derivatives including 3-alkylrhodanines such as 3-ethylrhodanine, and 3-allylrhodanine; and 3-arylrhodanines such as 3-phenylrhodanine;
(g) 2-thio-2,4-oxazolidinedione (2-thio-2,4-(3H,5H)-oxazoledione) nuclei such as 2-ethyl-2-thio-2,4-oxazolidinedione;
(h) thianaphthenone nuclei such as 3(2H)-thianaphthenone and 3(2H)-thianaphthenone-1,1-dioxide,
(i) 2-thio-2,5-thiazolidinedione nuclei such as 3-ethyl-2-thio-2,5-thiazolidinedione;
(j) 2,4-thiazolidinedione nuclei such as 2,4-thiazolidinedione, 3-ethyl-2,4-thiazolidinedione, and 3-phenyl-2,4-thiazolidinedione;
(k) thiazolidinone nuclei such as 4-thiazolidinone, and 3-ethyl-4-thiazolidinone;
(l) 4-thiazolinone nuclei such as 2-ethylmercapto-5-thiazoline-4-one, and 2-alkylphenylamino-5-thiazoline-4-one;
(m) 2-imono-2-oxazoline-4-one (pseudo-hydantoin)nuclei,
(n) 2,4-imidazolidinedione(hydantoin)nucei such as 2,4-imidazolidinedione, and 3-ethyl-2,4-imidazolidinedione;
(o) 2-thio-2,4-imidazolidinedione(2-thiohydantoin)nuclei such as 2-thio-2,4-imidazolidinedione, and 3-ethyl-2-thio-2,4-imidazolidinedione, and
(p) 2-imidazoline-5-one nuclei such as 2-n-propyl-mercapto-2-imidazoline-5-one; and
(q) furan-5-one.

In order for the melocyanine dye represented by formula (II) to be used as the light absorbing moiety S of the new photopolymerization initiator used in the invention, it is necessary that any one of R¹, R², R³, G¹ and G² has at least one functional group necessary for reacting with a compound containing the active moiety A to form the linking group L for linking the light absorbing moiety S and the active moiety A. Examples of the functional group include carboxyl, hydroxyl, amino, sulfonyl, isocyanate, thioisocyanate, and thiol groups.

The following describes a compound which can turn to the active moiety A of the compound represented by formula (I). A typical example of the compound which can form the active moiety A is an S-triazine compound containing a trichloromethyl group. Specifically, a compound represented by the following formula (III) is preferable:

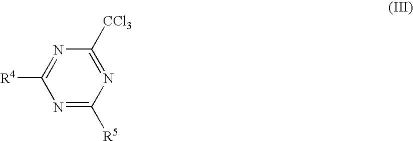

In formula (III), R⁴ and R⁵ each independently represent a hydrogen atom, or an alkyl, substituted alkyl, aryl, substituted aryl, alkenyl or substituted alkenyl group. It is necessary that at least one of R⁴ and R⁵ has at least one functional group necessary for reacting with a compound containing the light absorbing moiety S to form the linking group L.

Examples of the substituted alkyl group represented by R⁴ or R⁵ include trichloromethyl, and trifluoromethyl groups. Examples of the substituted aryl group include 4-styrylphenyl and 4-(substituted) styrylphenyl groups. Examples of the substituted alkenyl group include styryl and substituted styryl groups. Examples of the aryl group include polycyclic aromatic compound residues such as a naphthyl group, and hetero aromatic compound residues such as thiofurane.

Examples of the functional group necessary for linking the active moiety A with the light absorbing moiety S are the same as those used in formula (II).

Specific examples (compounds S1 to S42) of the photopolymerization initiator that are preferably used in the invention are illustrated below. However, in the invention, the photopolymerization initiator is not limited thereto.

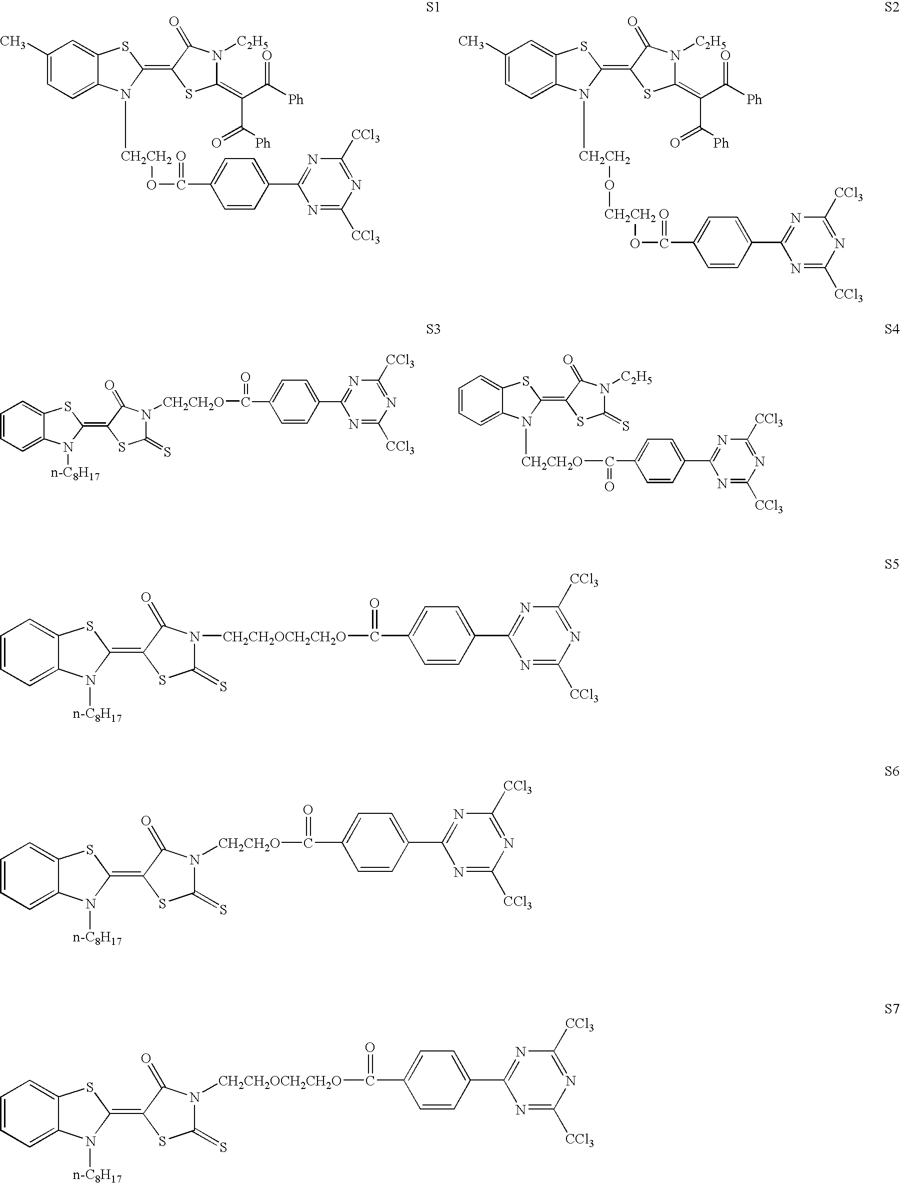

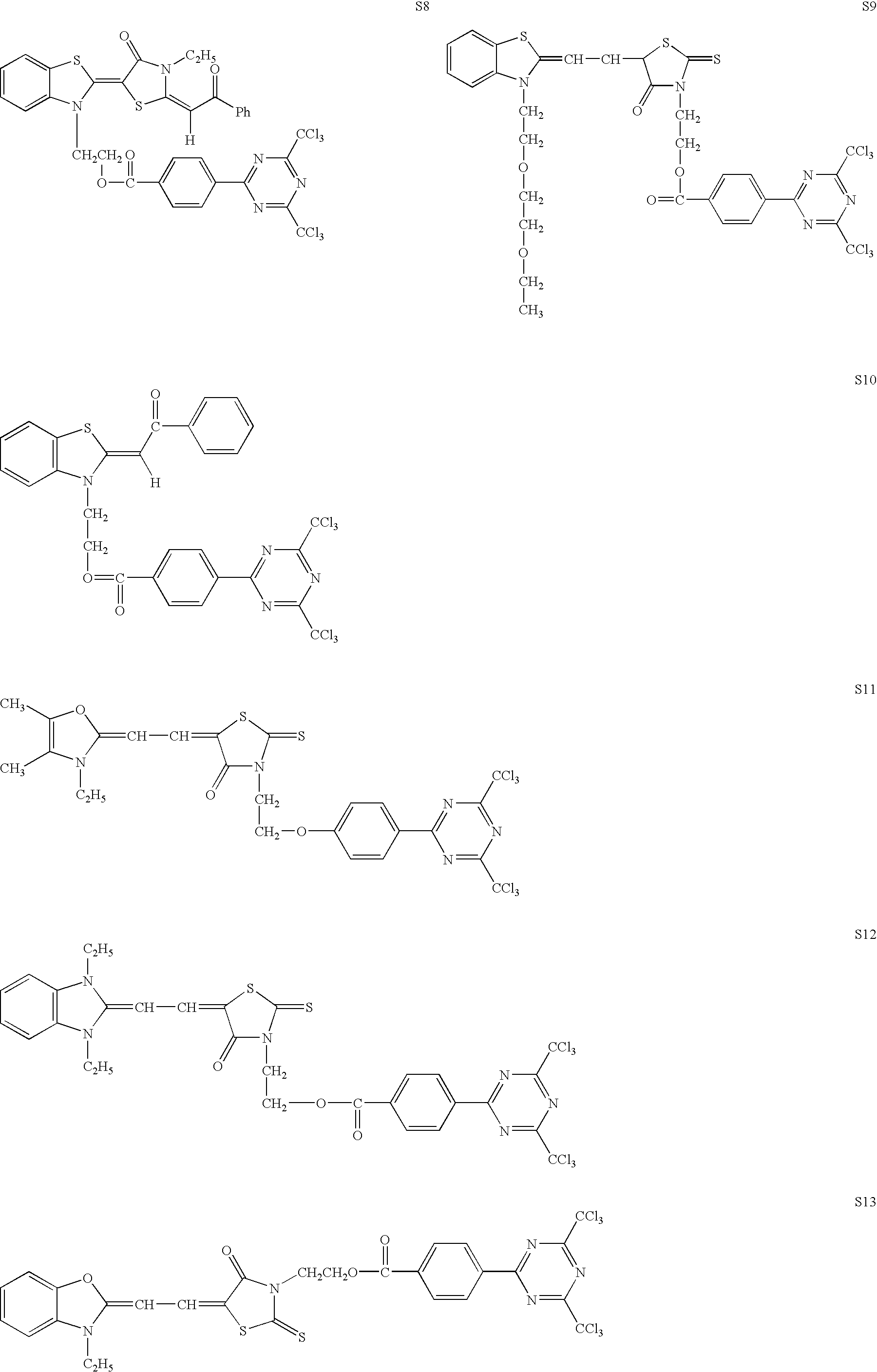

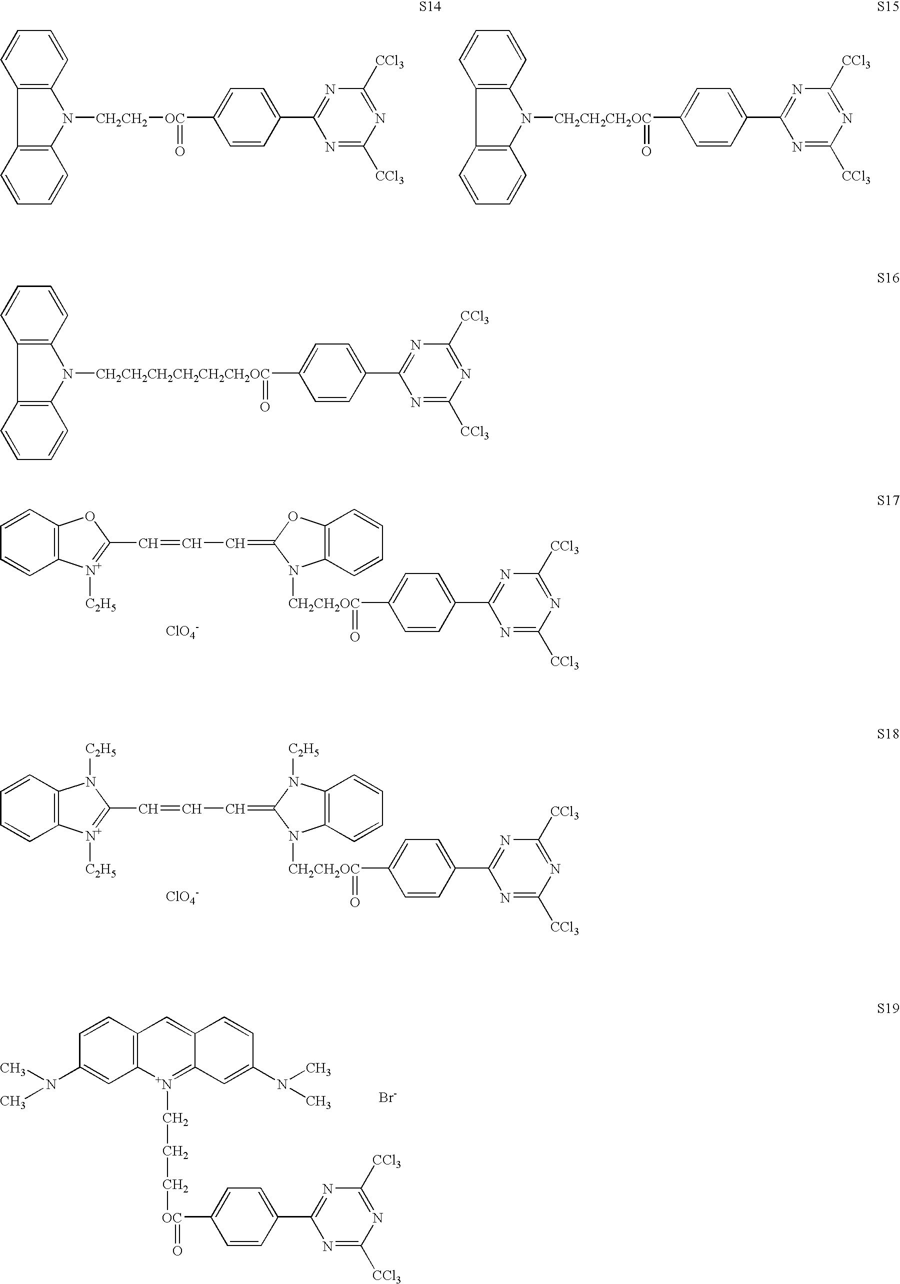

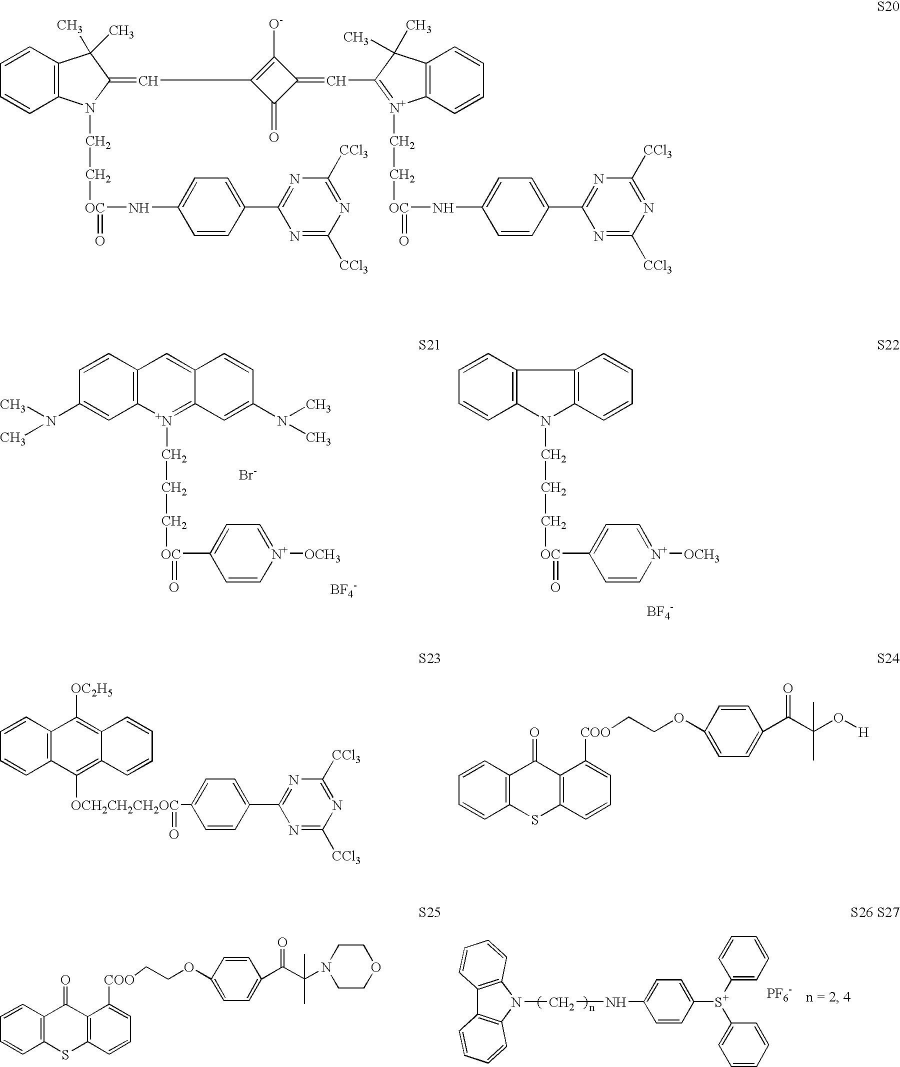

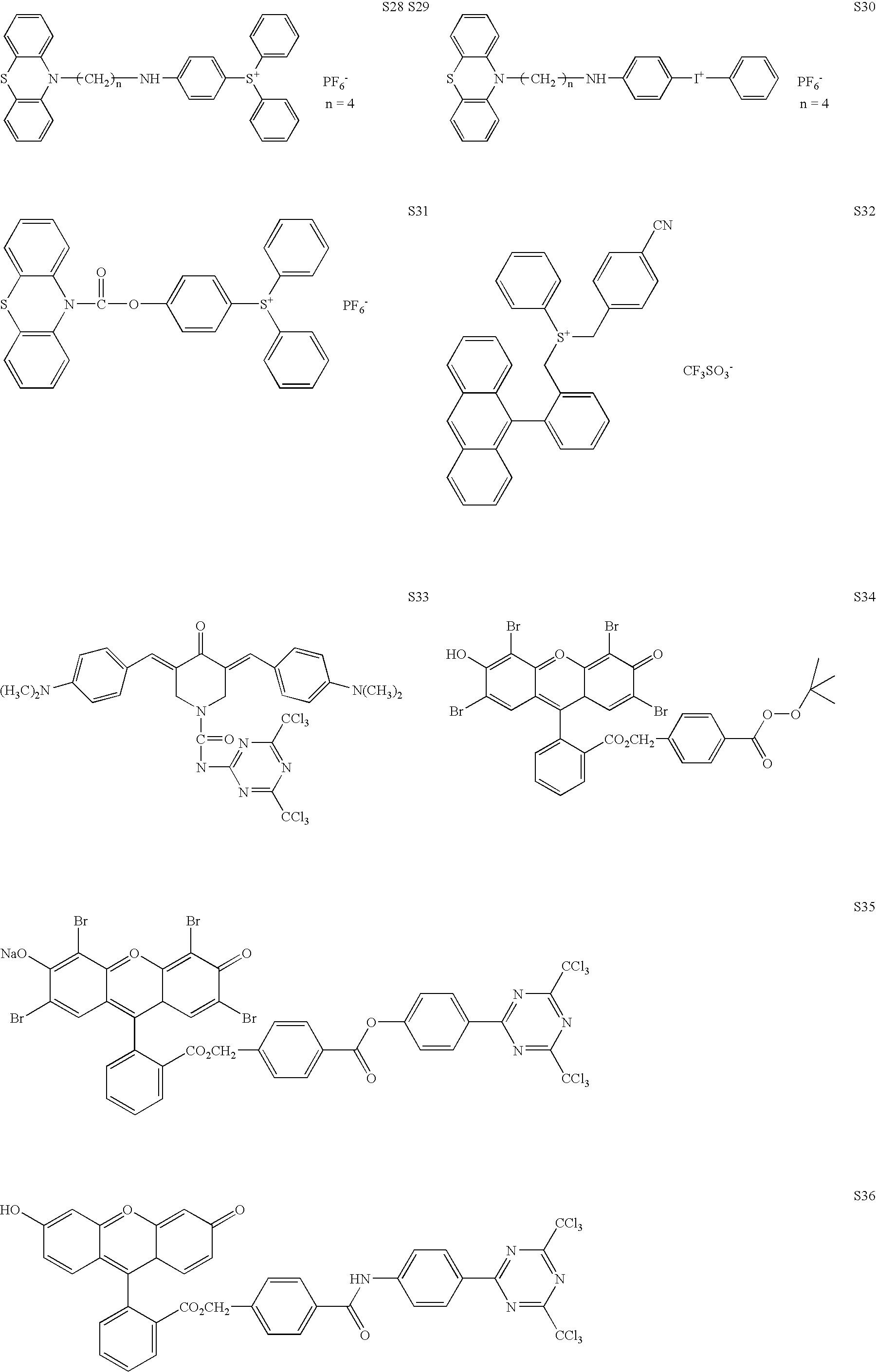

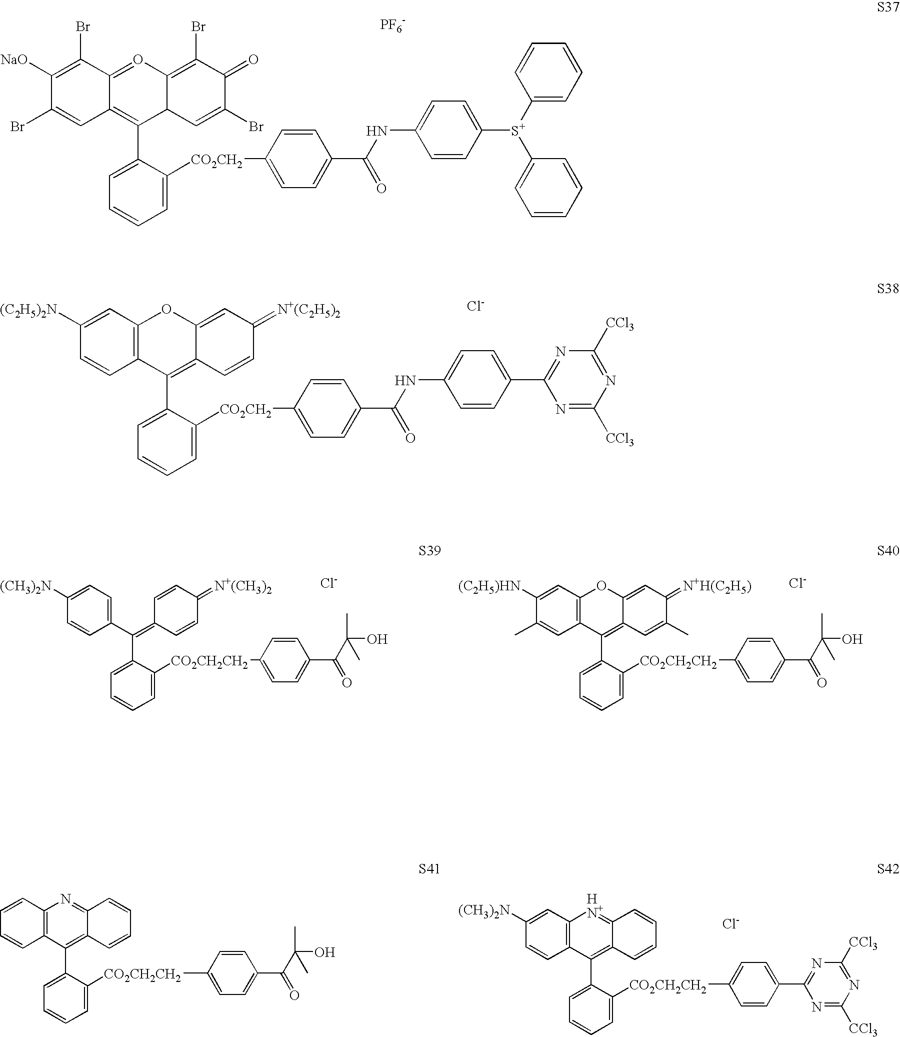

The amount of the photopolymerization initiator included in the photosensitive composition is preferably from 0.01 to 10% by mass, more preferably from 0.1 to 5% by mass, and most preferably from 0.1 to 3.0% by mass of all solid contents in the photosensitive composition. Moreover, the amount of the initiator is from 0.01 to 10 parts, and preferably from 0.1 to 5.0 parts by mass for 100 parts by mass of the binder resin (A), which will be detailed later.

It is preferable to subject the photopolymerization initiator to decomposing treatment after recording a hologram, in order to stabilize the recorded hologram.

In the photosensitive composition of the invention, a known polymerization initiator, besides the photopolymerization initiator represented by formula (I), can also be used as long as the advantageous effects of the invention are not damaged.

Binder Polymer (A)

The following describes the binder polymer (A). The binder polymer (A) which can be used in the invention may be a polymer selected from polymers satisfying ordinary properties required of volume holograms, that is, physical properties such as transparency, film physical properties, and a refractive index difference from the polymer made from the photopolymerizable compound and generated in a portion intensely-exposed at the time of interference exposure.

Specific examples of the binder polymer include polymethacrylic acid esters and partially-hydrolyzed products thereof; polyvinyl acetate and hydrolyzates thereof; polyvinyl alcohol and partially-acetalized products; triacetylcellulose; polyisoprene; polybutadiene; polychloroprene; silicone rubber; polystyrene; polyvinyl butyral; polyvinyl chloride; chlorinated polyethylene; chlorinated polypropylene; poly-N-vinylcarbazole and derivatives thereof; poly-N-vinylpyrrolidone and derivatives thereof; copolymers made of styrene and maleic anhydride, and semi-esterified products thereof; and copolymers made from two or more components at least one of which is selected from copolymerizable monomers such as acrylic acid, acrylic acid ester, methacrylic acid, methacrylic acid ester, acrylamide, acrylonitrile, ethylene, propylene, vinyl chloride and vinyl acetate. These may be used alone or in the form of a mixture comprising two or more thereof.

Particularly preferable are polyisoprene, polybutadiene, polychloroprene, polyvinyl alcohol, polyvinyl acetal, which is a partially-acetalized product of polyvinyl alcohol, polyvinyl butyral, polyvinyl acetate, an ethylene-vinyl acetate copolymer, a vinyl chlorode-vinyl acetate copolymer, and mixtures thereof.

When a recording medium film using the hologram recording photosensitive composition is used to form a volume hologram, the step of shifting the polymerizable compound in the film by heating is generally performed as the step of promoting the refractive index change generated by interference exposure after the step of light-exposure, or stabilizing the recorded hologram. In order to shift the polymerizable compound in the film effectively by the heating, the matrix polymer of the film is preferably a polymer having a relatively low glass transition temperature to make the shift of the monomers easy before the polymer is completely cured. From this viewpoint, specifically, the matrix polymer is preferably a polymer having a glass transition temperature of 180° C. or less.

The amount of the binder polymer included in the photosensitive composition is preferably from 10 to 99% by mass, and more preferably from 30 to 80% by mass of all solid contents in the composition.

Polymerizable Compound (B)

The polymerizable compound (B) used in the photosensitive composition of the invention may be a radical polymerizable compound or a cationic polymerizable compound.

i) Radical Polymerizable Compound

The radical polymerizable compound may be a compound having at least one ethylenic unsaturated double bond, which can undergo addition polymerization. Examples thereof include unsaturated carboxylic acids and salts thereof; esters each made from an unsaturated carboxylic acid and an aliphatic polyhydric alcohol compound; and amide compounds each made from an unsaturated carboxylic acid and an aliphatic polyvalent amine.

The radical polymerizable compound may specifically be a monomer which is an ester made from an aliphatic polyhydric alcohol compound and an unsaturated carboxylic acid. Examples thereof are as follows:
acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetracrylate, dipentaerythritol diacrylate, dipentaerythritol triacrylate, dipentaerythritol tetraacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, polyester acrylate oligomer, 2-phenoxyethyl acrylate, 2-phenoxyethyl methacrylate, phenolethoxylate monoacrylate, 2-(p-chlorophenoxy)ethyl acrylate, p-chlorophenyl acrylate, phenyl acrylate, 2-phenylethyl acrylate, (2-acryloxyethyl)ether of bisphenol A, ethoxidized bisphenol A diacrylate, 2-(1-naphthyloxy)ethyl acrylate, and o-biphenyl methacrylate, and o-biphenyl acrylate;
methacrylic acid esters such as tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis-[p-(3-methacryloxy-2-hydroxypropoxy)phenyl]dimethylmethane, bis-[p-(acryloxyethoxyphenyl)]dimethylpropane, 2,2-bis-(4-methacryloyloxyphenyl)propane, and 2-naphthyl methacrylate.
   ii) Cationic Polymerizable Compound

Examples of the cationic polymerizable compound include cyclic ethers such as compounds which each contain an epoxy ring and an oxetane ring; thioethers; and vinyl ethers.

Specific examples of these compounds include polyalkylene glycol diglycidyl ether, bisphenol A diglycidyl ether, glycerin triglycidyl ether, diglycerol triglycidyl ether, diglycidyl hexahydrophthalate, trimethylolpropane diglycidyl ether, allyl glycidyl ether, phenyl glycidyl ether, and cyclohexene oxide as compounds which each contain an epoxy ring; and 3-ethyl-3-[(2-ethylhexyloxy)methyl]oxetane, and bis{[1-ethyl(3-oxetanyl)]methyl}ether as compounds which each contains an oxetane ring.

In the invention, it is preferable to use a photopolymerizable compound having a low refractive index in order to enlarge the refractive index difference between the polymerizable compound and the binder polymer (A). Preferable examples of a monomer having a refractive index of 1.49 or less include aliphatic monomers such as polyethylene glycol monoacrylate, polyethylene glycol diacrylate, polyethylene glycol monomethacrylate, polyethylene glycol dimethacrylate, trimethylolpropane acrylate, trimethylolpropane trimethacrylate, hexanediol diacrylate, and pentaerythritol tetraacrylate; and fluorine-containing monomers 1H, 1H,2H,2H-heptadecafluorodecyl methacrylate (for example, Viscoat 17FM (trade name), manufactured by Osaka Organic Chemical Industry Ltd.), 1H,1H,5H-octafluoropentyl methacrylate (for example, Viscoat 8FM (trade name), manufactured by Osaka Organic Chemical Industry Ltd.), 2-(perfluoro-3-methylbutyl)ethyl methacrylate (M-3420 (trade name), manufactured by Daikin Industries, Ltd.), 2-(perfluorodecyl)ethyl methacrylate (M-2020 (trade name), manufactured by Daikin Industries, Ltd.), 3-(1H,1H,9H-hexadecafluorononyloxy)-1,2-epoxypropane (E-5844 (trade name), manufactured by Daikin Industries, Ltd.), and 1,4-bis(2′,3′-epoxypropyl)-perfluoro-n-butane (E-7432 (trade name), manufactured by Daikin Industries, Ltd.).

Oligomers or polymers of the compounds exemplified above can also be used.

The polymerizable compound (B) is preferably contained in an amount of 1 to 80% by mass of all solid contents in the photosensitiive composition of the invention, and more preferably in an amount of 10 to 60% by mass thereof. The amount of the compound (B) is preferably from 10 to 1000 parts, and more preferably from 10 to 100 parts by mass for 100 parts by mass of the binder polymer (A), which is used together.

Solvent (D)

The volume hologram recording photosensitive composition is dissolved in a suitable solvent, and the solution is applied onto a support. Examples of the solvent suitable for the photosensitive composition include acetone, methyl ethyl ketone, methyl isobutyl ketone, cyclohexanone, benzene, toluene, xylene, chlorobenzene, tetrahydrofuran, methylcellosolve, ethylcellosolve, methylcellosolve acetate, ethylcellosolve acetate, ethyl acetate, 1,4-dioxane, 1,2-dichloroethane, dichloromethane, chloroform, methanol, ethanol, and isopropanol. A solvent made of a mixture thereof can also be used.

When a coating solution of the photosensitive composition is prepared, the solid content in the coating solution is preferably from about 10 to 50% by mass for uniform application of the solution.

The following describes the volume hologram recording medium of the invention. This recording medium has, on a support, a photosensitive layer made of a volume hologram recording photosensitive composition comprising the binder resin (A), the polymerizable compound (B), and the photopolymerization initiator (C) represented by formula (I). The amount of the initiator (C) is preferably from 0.1 to 3.0% by mass.

Support

Typical examples of the support used in the volume hologram recording photosensitive medium may be a transparent supporting film. Examples thereof include resin films such as polyethylene, polypropylene, polyethylene fluoride, polyvinylidene fluoride, polyvinyl chloride, polyvinylidene chloride, ethylene-vinyl alcohol, polyvinyl alcohol, polymethyl methacrylate, polyethersulfone, polyether ether ketone, polyamide, tetrafluoroethylene-perfluoroalkyl vinyl ether copolymer, polyester (for example, polyethylene terephthalate), and polyimide films.

The film thickness of the support, which may be appropriately selected in accordance with the purpose, is generally from 2 to 200 μm, and preferably from 10 to 50 μm.

The recording medium of the invention is obtained by forming, on the support, a photosensitive layer made of the volume hologram recording photosensitive composition of the invention. The photosensitive layer is usually formed by applying a coating solution of the photosensitive composition (i.e., a photosensitive layer coating solution) onto the support.

The photosensitive layer coating solution is prepared by dissolving the photosensitive composition of the invention into a suitable solvent as described above. The volume hologram recording photosensitive medium of the invention is obtained by applying the coating solution onto the support by a coating method using a spin coater, a gravure coater, a comma coater, a bar coater or some other coater, and then drying the applied solution.

The thickness of the photosensitive layer made of the volume hologram recording photosensitive composition is preferably made as large as possible in order to multiplex-record information in some volume as much as possible. Even in this case, it is impossible to make best use of a large refractive index change in the composition material if the optical density (OD) of the photosensitive layer is high. It is therefore preferable that the optical density is low.

From these viewpoints, the thickness of the photosensitive layer is preferably from 50 to 2000 μm, more preferably from 100 to 1000 μm, and most preferably from 200 to 500 μm. In order to cure the photosensitive layer homogeneously up to a deep part thereof by polymerization, the optical density (OD) of the photosensitive layer having this thickness is preferably 0.4 or less, more preferably 0.3 or less, and most preferably 0.2 or less.

In the case where the volume hologram recording photosensitive composition has adhesiveness after being dried, the surface of the photosensitive layer can be protected by laminating a protective film thereon. The protective film may be, for example, a thin-layer film which is made of one or more selected from the materials exemplified as the material for the support and has a thickness of about 0.1 to 5 μm. This film is laminated in order to be used as the protective film. In this case, the surface of the laminating film which contacts the volume hologram material layer may be subjected to releasing treatment, so that the film can be easily peeled afterwards.

The thus-obtained volume hologram recording medium of the invention is subjected to a recording step of using interference exposure, thereby forming a volume hologram.

For recording the hologram, a laser ray can be used. Examples of the ray include visible laser rays, for example, rays from an argon ion laser (458 nm, 488 nm, and 514.5 nm), a krypton ion laser (647.1 nm), and a YAG laser (532 nm).

Formation of a Volume Hologram

It can be considered that the mechanism for recording a volume hologram in the volume hologram recording medium of the invention is the same as in prior art.

When the photosensitive layer of the recording medium (that is, the photosensitive composition formed in a film form) is subjected to interference exposure, photopolymerization is started in intensely-exposed portions. A concentration gradient of the photopolymerizable compound can be generated accordingly. Molecules of the photopolymerizable compound diffuse and move from faintly-exposed portions to the intensely-exposed portions. As a result, areas where the photopolymerizable compound is densely present and areas where the binder polymer is present as the main component are formed according to the intenseness and faintness of the interferential light. Refractive index difference between these areas causes a hologram to appear.

The Δn calculated according to Kogelnik's theory represents the refractive index difference in the refractive index distribution formed in accordance with interferential light radiated into the photosensitive layer. The larger the Δn, the better the hologram. In the invention as well, the refractive index difference between the intensely-exposed portions and faintly-exposed portions or non-exposed portions, resulting from interference exposure, can be evaluated on the basis of the Δn calculated according to Kogelnik's theory.

The refractive index difference between the intensely-exposed portions and faintly-exposed portions or non-exposed portions, resulting from interference exposure, is desirably 0.01 or more, regardless of whether the refractive index of the former areas is larger than that of the latter areas.

In this way, interference fringes are generated in the hologram recording material layer (photosensitive layer) of the volume hologram recording photosensitive medium according to the invention by interference exposure, whereby the layer turns to a hologram layer. As a result, a volume hologram is obtained.

The photosensitive composition of the invention is superior in recording sensitivity even with a small amount of the added photopolymerization initiator; therefore, in the recording medium of the invention, information can be recorded at high sensitivity. As the amount of the photopolymerization initiator and decomposed products therefrom remaining in the photosensitive layer in the resultant hologram is minimal, transparency of the hologram is excellent. Therefore, an excellent volume hologram with a large refractive index difference can be obtained.

In the recording medium of the invention, excellent properties are obtained while the amount of the added photopolymerization initiator can be suppressed. Thus, the recording medium is cost-competitive and has an advantage in reducing the likelihood of adverse effects of the photopolymerization initiator in the event that the medium contacts the skin at the time of handling the medium.

### EXAMPLES

### Example 1

Components of the following composition were blended to prepare a volume hologram recording photosensitive composition:

| | |
|---|---|
| polymethyl methacrylate | 100 parts by weight, |
| (Elvacite 2041 (trade name), | |
| manufactured by Du Pont) | |
| polyethylene glycol dimethacrylate | 60 parts by weight, |
| (9G (trade name), manufactured by | |
| Shin-Nakamura Chemical Co., Ltd.) | |
| photopolymerization initiator | 0.23 part by weight, |
| (illustrated compound S1) | |
| toluene | 30 parts by weight, |
| methyl ethyl ketone (MEK) | 30 parts by weight, |
| and | |
| tetrahydrofuran (THF) | 40 parts by weight. |

A bar coater was used to apply the above-mentioned photosensitive composition solution onto a polyethylene terephthalate (PET) film (Lumirror T-60 (trade name), manufactured by Toray Industries, Inc.) having a thickness of 38 μm in such a manner that the thickness of the dried film would be 200 μm. In this way, a volume hologram recording photosensitive medium was produced. The optical density of the photosensitive layer was 0.19 at a wavelength of 488 nm.

The medium was laminated onto a mirror in such a manner that the photosensitive layer was brought into contact with the mirror. From the support (PET film) side of the medium, a 488-nm argon ion laser ray was radiated onto the medium to record a volume hologram.

Next, the volume hologram was fixed by heating and polymerization with ultraviolet rays. The Δn thereof was calculated from spectroscopic analysis results thereof. The Δn was 0.058.

### Comparative Example 1

A photosensitive composition was obtained and a volume hologram was formed in the same way as in Example 1 except that instead of the illustrated compound S 1 as the photopolymerization initiator, the following photopolymerization initiator system was used: a system wherein 0.15 part by weight of a sensitizing dye R1 illustrated below was combined with 0.11 part by weight of a polymerization initiator R2 having no structure of formula (I) and illustrated below; and the dyes R1 and R2 were separately incorporated.

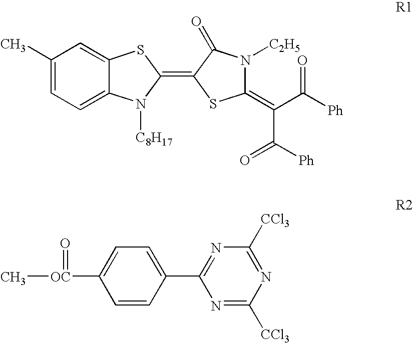

As a result, hardly any polymerization advanced, and the Δn of the hologram, which was calculated from spectroscopic analysis results thereof, was 0.011. This demonstrated that the hologram performance of Comparative Example 1 was lower than that of Example 1

### Example 2

A photosensitive composition was prepared in the same way as in Example 1 except that 0.38 part by weight of the illustrated compound S13 was used as a photosensitive initiator instead of the illustrated compound S1.

A bar coater was used to apply this photosensitive composition solution onto a polyethylene terephthalate (PET) film (Lumirror T-60 (trade name), manufactured by Toray Industries, Inc.) having a thickness of 38 μm in such a manner that the thickness of the dried film would be 200 μm. In this way, a volume hologram recording photosensitive medium was produced. The optical density of the photosensitive layer was 0.18 at a wavelength of 532 nm.

The medium was laminated onto a mirror in such a manner that the photosensitive layer was brought into contact with the mirror. From the PET film side of the medium, a 532-nm Nd:YAG laser ray was radiated onto the medium to record a volume hologram.

Next, the volume hologram was fixed by heating and polymerization with ultraviolet rays. The Δn thereof was calculated from spectroscopic analysis results thereof. The Δn was 0.058.

### Comparative Example 2

A photosensitive composition was obtained and a volume hologram was formed in the same way as in Example 2 except that instead of the illustrated compound S13 as the photopolymerization initiator, the following photopolymerization initiator system was used: a system wherein 0.17 part by weight of a sensitizing dye R3 illustrated below was combined with 0.22 part by weight of the polymerization initiator R2, having no structure of formula (I) and illustrated below; and the dyes R3 and R2 were separately incorporated.

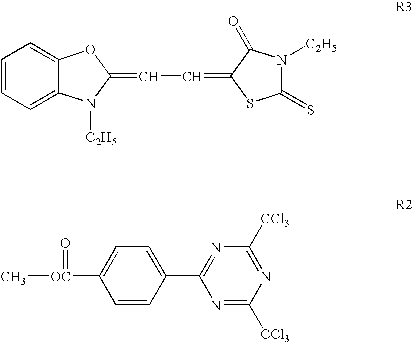

As a result, hardly any polymerization advanced, and the Δn of the hologram, which was calculated from spectroscopic analysis results thereof, was 0.006. This demonstrated that the hologram performance of Comparative Example 2 was lower than that of Example 2.

It can be understood from comparison of the Examples with the Comparative Examples that the photosensitive composition of the invention using a photopolymerization initiator represented by formula (I) can give a volume hologram film having better properties than compositions where a sensitizing dye and an initiator are separately incorporated.

1. A volume hologram recording photosensitive composition comprising a binder resin, a polymerizable compound, and a photopolymerization initiator represented by formula (I):
S-L-A Formula (I)
wherein S represents a light absorbing moiety having a chromophoric group structure in which absorption giving an absorption coefficient of 1000 or more is caused for wavelengths longer than 300 nm; A represents an active moiety interacting with the light absorbing moiety S that is optically excited, so as to generate a free radical; and L represents a linking group for linking the light absorbing moiety S with the active moiety A.

2. A volume hologram recording photosensitive composition according to claim 1, in which the photopolymerization initiator is contained in an amount of 0.1 to 3.0% by mass.

3. A volume hologram recording photosensitive composition according to claim 1, in which in formula (I) the linking group L is a linking group containing one or more bonds selected from the group consisting of methylene, ester, amide, sulfonamide, ether and thioether bonds, and the light absorbing moiety S and the active moiety A are linked with each other through a non-conjugated bond.

4. A volume hologram recording photosensitive composition according to claim 1, in which in formula (I) the light absorbing moiety S is a residue of a dye selected from melocyanine, cyanine, squalium, dibenzylacetone, xanthene, triphenylmethane and acridinium dyes, or a residue of a compound selected from thioxanthone, anthracene, phenanthrene, pyrene, acridine, carbazole and phenothiazine, or a residue of a derivative of the compound.

5. A volume hologram recording photosensitive composition according to claim 1, in which the linking bond L comprises one or more bonds selected from the group consisting of methylene, ester, amide, sulfonamide, ether and thioether bonds.

6. A volume hologram recording photosensitive composition according to claim 1, in which the linking group L comprises one or more bonds selected from the group consisting of an ester bond represented by the following formula (a) or (b), amide bonds represented by the following formulae (c) to (f), a sulfonamide bond represented by the following formula (g), and ether, thioether and amino bonds: 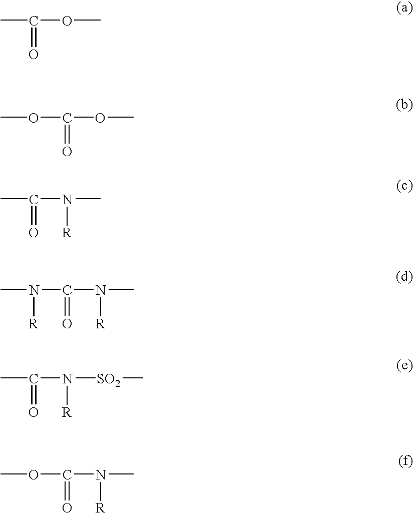
wherein Rs each independently represent a hydrogen atom, an alkyl group or an aryl group, 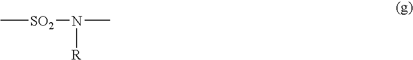
wherein R represents a hydrogen atom, an alkyl group or an aryl group.

7. A volume hologram recording medium comprising a support having provided thereon a photosensitive layer made of a volume hologram recording photosensitive composition comprising a binder resin, a polymerizable compound, and a photopolymerization initiator represented by formula (I):
S-L-A (I)
wherein S represents a light absorbing moiety having a chromophoric group structure in which absorption giving an absorption coefficient of 1000 or more is caused for wavelengths longer than 300 nm; A represents an active moiety interacting with the light absorbing moiety S that is optically excited, so as to generate a free radical; and L represents a linking group for linking the light absorbing moiety S with the active moiety A.

8. A volume hologram recording medium according to claim 7, in which the thickness of the photosensitive layer ranges from 50 to 2000 μm, and the optical density of the photosensitive layer is 0.4 or less at a wavelength of light from a light source for exposing the layer.

9. A volume hologram recording medium according to claim 7, wherein the photopolymerization initiator is contained in an amount of 0.1 to 3.0% by mass.

10. A volume hologram recording medium according to claim 7, wherein in formula (I) the linking group L is a linking group containing one or more bonds selected from the group consisting of methylene, ester, amide, sulfonamide, ether and thioether bonds, and the light absorbing moiety S and the active moiety A are linked with each other through a non-conjugated bond.

11. A volume hologram recording medium according to claim 7, wherein in formula (I) the light absorbing moiety S is a residue of a dye selected from melocyanine, cyanine, squalium, dibenzylacetone, xanthene, triphenylmethane and acridinium dyes, or a residue of a compound selected from thioxanthone, anthracene, phenanthrene, pyrene, acridine, carbazole and phenothiazine, or a residue of a derivative of the compound.

12. A volume hologram recording medium according to claim 7, wherein the linking bond L comprises one or more bonds selected from the group consisting of methylene, ester, amide, sulfonamide, ether and thioether bonds.

13. A volume hologram recording medium according to claim 7, wherein the linking group L comprises one or more bonds selected from the group consisting of an ester bond represented by the following formula (a) or (b), amide bonds represented by the following formulae (c) to (f, a sulfonamide bond represented by the following formula (g), and ether, thioether and amino bonds: 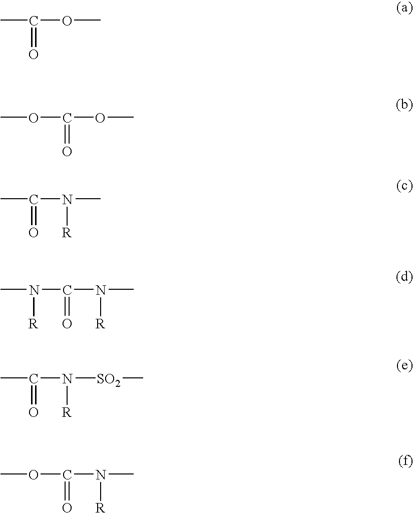
wherein Rs each independently represent a hydrogen atom, an alkyl group or an aryl group, 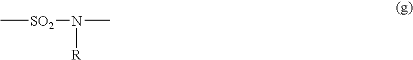
wherein R represents a hydrogen atom, an alkyl group or an aryl group.
